(19) United States
(12) Patent Application Publication
(10) Pub. No.: US 2012/0327013 A1
(43) Pub. Date: Dec. 27, 2012

(54) METHOD AND APPARATUS FOR INITIATING OPERATIONS ON A TOUCH DEVICE

(76) Inventors: Jeffery T. LEE, San Jose, CA (US); James Eric Mason, Campbell, CA (US)

(21) Appl. No.: 13/166,649

(22) Filed: Jun. 22, 2011

(51) Int. Cl. G06F 3/045

(52) U.S. Cl. 345/174

(57) ABSTRACT

An electronic device having conductive bumps on one of its surfaces or areas can be used to initiate operation on another device with a touch panel. The electronic device includes a device housing; a first surface coupled to the device housing; and a plurality of conductive bumps on the first surface, the conductive bumps configured to be detectable by a capacitive touch panel of a touch sensing device when placed in contact with the capacitive touch panel and having a unique configuration that identifies the electronic device to the touch sensing device.

### FIELD

This relates generally to a method of communication between two or more devices, and more specifically, to using conductive bumps on the back surface of a portable device to initiate operations on an electronic device with a touch panel or screen.

### BACKGROUND

In recent years, touch sensor panels, touch screens, and the like have become widely available as input devices. Touch screens, in particular, are becoming increasingly popular because of their ease and versatility of operation as well as their declining price. They can now be found in various types of electronic devices such as mobile phones, portable music players, cameras, global positioning systems (GPS), and tablet personal computers (PC).

Typically, touch data captured by a touch panel of an electronic device can be used to determine the location, the contact area, and in some cases even the force of the one or more touches detected by the touch screen. The touch data can then be interpreted by a processor to perform various operations on the electronic device. However, the touch data collected by existing touch screens may not be sufficient to determine the type or identity of the touch object touching the screen, especially when the object is not one that is typically used for interacting with a touch screen, such as a finger or a stylus.

Because of the limited capability of identifying unconventional touch objects, most existing electronic devices with touch screens are only designed to operate in response to location and movement associated with one or more detected touches. However, they are not typically designed to respond differently based on touches by different types of touch objects. This may not be a significant drawback given that conventional touch screens are designed only to be operated by a finger or a stylus.

Nevertheless, with the proliferation of touch-based electronic devices, it is not uncommon for a person to own multiple devices such as, for example, a smartphone, a portable music player, and a tablet PC, and each may be used to download and store a variety of data such as contact information, pictures, MP3 files, and video clips. However, each of these devices is typically designed to operate alone, and therefore the transferring of data between two devices is often not simple and straightforward. For example, it may require that both devices be connected to each other using a physical cable or through an intermediate computer in order to synchronize the devices. Other communication channels such as the cellular network may be available, but are often not free. In particular, there is no known method that allows one device to use the touch screen of another device to establish communication between the devices and initiate operations on one or both of the devices in a fast and intuitive way.

### SUMMARY

This generally relates to initiating operations on a device with a touch panel or touch screen using conductive bumps or areas on a surface of another device. The device with the touch panel or touch screen is hereinafter referred to as the touch sensing device. The device with conductive bumps or areas on one of its surfaces is hereinafter referred to as the touch object device. The conductive bumps or areas on the touch object device can be configured to interact with the touch panel or touch screen of the touch sensing device. Various configurations of conductive bumps or areas can be used by the touch sensing device to identify the touch object device. In addition, a unique configuration of conductive bumps can also initiate certain operations on the touch sensing device. In some embodiments, the conductive bumps can also serve as an input channel for transmitting information from the touch object device to the touch sensing device.

When in use, the touch object device can be placed in contact with or in close proximity to the touch panel or touch screen of the touch sensing device, with the conductive bumps on one of its surfaces facing the touch panel or touch screen of the touch sensing device. This way, the touch panel or touch screen can capture a touch image corresponding to the configuration of the conductive bumps of the touch object device. Based on the detected configuration, the touch sensing device can identify the device type of the touch object device. After the touch object device is identified, the touch sensing device can use its touch panel or touch screen to receive information from the touch object device, open a secondary channel to communicate with the touch object device using a common protocol, or initiate other operations on one or both of the two devices. For example, the touch object device and the touch sensing device can be synchronized after a communication channel is established so that data stored in one device can be transferred to the other device in a seamless fashion.

### BRIEF DESCRIPTION OF THE DRAWINGS

FIG. 1a illustrates the underlying structure of an exemplary capacitive touch sensor panel.

FIG. 1b and 1c illustrate the capacitive touch sensor panel of FIG. 1a at work.

FIG. 2 illustrates the back surface of an exemplary portable electronic device with a particular configuration of conductive bumps according to embodiments of the disclosure.

FIG. 3 provides a side view of an exemplary portable electronic device on top of a touch sensing device according to embodiments of the disclosure.

FIG. 4a-c illustrate various types of exemplary electronic devices, each with a different configuration of conductive bumps on its back surfaces according to embodiments of the disclosure.

FIG. 4d-h illustrate various conductive bump configurations capable of identifying the orientation and direction of an electronic device according to embodiments of the disclosure.

FIG. 5 illustrates the back surface of an exemplary portable electronic device with a configuration of conductive bumps including two sub-configurations according to embodiments of the disclosure.

FIG. 6a illustrates a front view of an exemplary touch sensing device with a touch screen display displaying normal-sized text according to embodiments of the disclosure.

FIG. 6b illustrates an exemplary portable device on top of the touch screen display of the touch sensing device of FIG. 5, the portable device magnifying the text displayed on the touch sensing device according to embodiments of the disclosure.

FIG. 7 illustrates the back surface of an exemplary physical keyboard attached with a strip having reconfigurable bumps according to embodiments of the disclosure.

FIG. 8 illustrates an exemplary physical keyboard of FIG. 7 placed partially over a touch sensing device, the physical keyboard configured to provide an input means for the touch sensing device, according to embodiments of the disclosure.

FIG. 9 illustrates an exemplary computing system that can incorporate device management according to embodiments of the disclosure.

FIG. 10 illustrates an exemplary control circuitry for controlling a conductive bump on a touch object device according to embodiments of the disclosure.

### DETAILED DESCRIPTION

In the following description, reference is made to the accompanying drawings which form a part hereof, and in which it is shown by way of illustration specific embodiments in which the disclosure can be practiced. It is to be understood that other embodiments can be used and structural changes can be made without departing from the scope of the embodiments of this disclosure.

This generally relates to initiating operations on a device with a touch panel or touch screen using conductive bumps or areas on a surface of another device. The device with the touch panel or touch screen is hereinafter referred to as the touch sensing device. The device with conductive bumps or areas on one of its surfaces is hereinafter referred to as the touch object device. The conductive bumps or areas on the touch object device can be configured to interact with the touch panel or touch screen of the touch sensing device. Various configurations of conductive bumps or areas can be used by the touch sensing device to identify the touch object device. The term “conductive bump,” as used hereinafter, is intended to cover conductive protrusions of different shapes, sizes and materials, conductive areas that may not protrude at all, and sub-surface areas that are capable of capacitively coupling to the touch sensing device, even though the surface area may itself not be conductive. In addition, a unique configuration of conductive bumps can also initiate certain operations on the touch sensing device. In some embodiments, the conductive bumps can also serve as an input channel for transmitting information from the touch object device to the touch sensing device.

When in use, the touch object device can be placed in contact with or in close proximity to the touch panel or touch screen of the touch sensing device, with the conductive bumps on one of its surfaces facing the touch panel or touch screen of the touch sensing device. This way, the touch panel or touch screen can capture a touch image corresponding to the configuration of the conductive bumps of the touch object device. Based on the detected configuration, the touch sensing device can identify the device type of the touch object device. After the touch object device is identified, the touch sensing device can use its touch panel or touch screen to receive information from the touch object device, open a secondary channel to communicate with the touch object device using a common protocol, or initiate other operations on one or both of the two devices. For example, the touch object device and the touch sensing device can be synchronized after a communication channel is established so that data stored in one device can be transferred to the other device in a seamless fashion.

As mentioned above, embodiments of the disclosure require that at least one of the devices (i.e., the touch sensing device) have a touch panel or touch screen for detecting the presence of one or more other devices. As will be discussed in the exemplary embodiments below, the touch panel can be a multi-touch touch screen. However, it should be understood that the touch panel is not limited to this type of touch screen and various embodiments of the disclosure can be easily extended or modified to work with other types of touch panels and touch screens. Therefore, term “touch panel,” as used hereinafter, is intended to cover various types of touch panels and touch screens. In the following paragraphs, a brief description of the structure and operation of a typical capacitive touch panel is first discussed before the various exemplary embodiments of the disclosure are introduced.

Capacitive touch panels are well known in the art and have been widely adopted in various types of electronic devices, such as tablet PCs (e.g., the iPad® from Apple Inc. of Cupertino, Calif. and smartphones (e.g., the iPhone® from Apple Inc. of Cupertino, Calif.). One popular type of capacitive touch panel can include a mutual capacitive touch sensor panel formed from drive and sense lines (e.g., rows and columns of traces) on opposite sides of a dielectric, or adjacent to each other on the same side of a substrate. At the “intersections” of the traces, where the traces pass above and below or are adjacent to each other (but do not make direct electrical contact with each other), the traces essentially form two electrodes. In one embodiment, touch panels for use over display devices may utilize a top layer of glass upon which transparent column traces of indium tin oxide (ITO) or antimony tin oxide (ATO) have been etched, and a bottom layer of glass upon which row traces of ITO have been etched. The top and bottom glass layers can be separated by a clear polymer spacer that acts as a dielectric between the row and column traces. Other touch panel configurations, such as those with drive and sense lines on opposite sides of a substrate or on the same side of a substrate, and self-capacitance touch panels are also contemplated for use with embodiments of the disclosure.

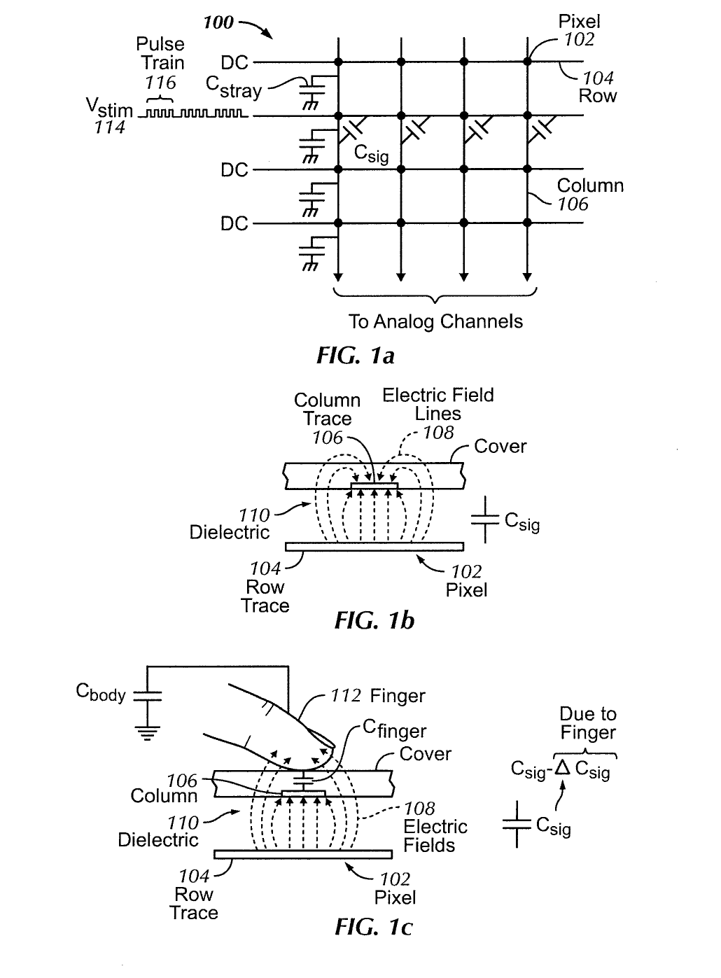

FIG. 1a illustrates an exemplary capacitive touch panel 100. FIG. 1a indicates the presence of a stray capacitance Cstray at each pixel 202 located at the intersection of a row 204 and a column 206 traces (although Cstray for only one column is illustrated in FIG. 1a for purposes of simplifying the figure). Note that although FIG. 1a illustrates rows 204 and columns 206 as being substantially perpendicular, they need not be so aligned. In the example of FIG. 1a, AC stimulus Vstim 214 is being applied to one row, with all other rows connected to DC. The stimulus causes a charge to be injected in to the column electrodes through mutual capacitance at the intersection points. Each of columns 206 may be selectively connectable to one or more analog channels.

FIG. 1b provides a side view of exemplary touch pixel 102 in a steady-state (no-touch) condition. In FIG. 1b, an electric field of electric field lines 108 of the mutual capacitance between column 106 and row 104 traces or electrodes separated by dielectric 110 is shown.

FIG. 1c provides a side view of exemplary pixel 102 in a dynamic (touch) condition. In FIG. 1c, a conductive object 112 has been placed near pixel 102. As shown, the conductive object 112 can be a human finger. However, it should be understood that the conductive object 112 can also be a stylus or anything else that is conductive such as one or more conductive bumps introduced later in various embodiments of the disclosure. The conductive object 112 can be a low-impedance object at signal frequencies, and can have an AC capacitance Cfinger from the column trace 104 to the object. The conductive object 112 can have a self-capacitance to ground Cbody that is much larger than Cfinger. If the conductive object 112 blocks some electric field lines 108 between the row and column electrodes (those fringing fields that exit the dielectric and pass through the air above the row electrode), those electric field lines can be shunted to ground through the capacitive path inherent in the conductive object, and as a result, the steady state signal or mutual capacitance Csig can be reduced by ΔCsig (which can also be referred to herein as Csig_sense). In other words, the capacitance of the conductive object can act as a shunt or dynamic return path to ground, blocking some of the electric fields and resulting in a reduced net signal capacitance. The signal capacitance at the pixel becomes Csig-ΔCsig, where Csig represents the static (no touch) component and ΔCsig represents the dynamic (touch) component. This change in capacitance can be used to detect a touch at the particular location (e.g., pixel 102) of the touch panel. Multiple touches can also be detected simultaneously on a touch panel by determining whether there is a change in capacitance at each of the pixels of the touch sensor panel using the same method as discussed above.

Embodiments of the disclosure can use one electronic device (i.e., the touch object device) to operate the touch panel of another device (i.e., the touch sensing device), thereby initiating operations on one or both devices. The touch panel of the touch sensing device can provide a convenient and direct mechanism to receive input and data from the touch object device. Using the touch data collected on the touch panel, the touch sensing device can identify the touch object device and recognize what type of device the touch object device is so that it can initiate communication between the two devices. This can allow data to be transmitted from one device and another seamlessly and efficiently. In some embodiments, the devices can also be operated jointly after they are identified to each other. As will be discussed in detail below, this can be achieved in a relatively cost-efficient way, without requiring significant modifications to the existing hardware of the devices.

In one aspect of embodiments of the disclosure, multiple conductive bumps can be fitted on or formed in one of the surfaces of the touch object device. The conductive bumps can be aligned in a unique configuration which serves as identification information for the touch object device. Embodiments of the disclosure can essentially utilize the unique configuration of conductive bumps to inform the touch sensing device that (1) an electronic device is being used as the touch object to operate the touch panel and (2) what type of device is being used as the touch object device. In operation, the touch object devices can be recognized by the touch sensing object when they are placed on the touch panel of the touch sensing device and a touch image of the unique configuration of the conductive bumps can be captured and processed by the touch sensing device. Once the touch object devices are identified by the touch sensing device, the devices can initiate data transfer or various other operations on one or both devices.

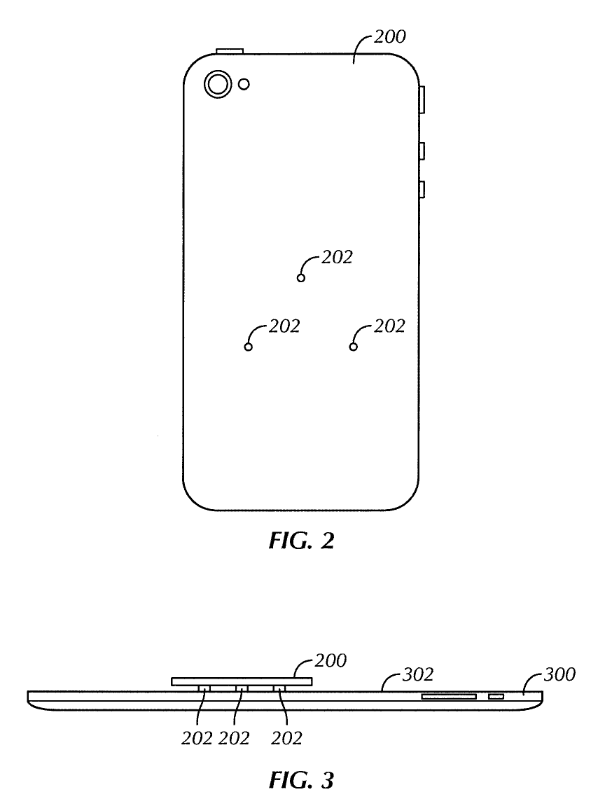

In one embodiment, the touch sensing device can be a tablet PC (e.g., an iPad®). The touch object device can be a portable electronic device (e.g., an iPhone®). FIG. 2 illustrates the back surface 200 of a portable electronic device having three conductive bumps (collectively 202) protruding therefrom or formed thereon and arranged in a specific configuration, in this embodiment, a triangular configuration. In this embodiment, the conductive bumps 202 can be fabricated as a permanent part of the housing of the portable electronic device. In other embodiments, the conductive bumps can be retrofitted on an existing portable electronic device as part of an accessory. For example, the conductive bumps can be affixed to the back surface of a case designed exclusively to fit over the housing of a particular portable electronic device. The case itself may or may not be conductive as long as the bumps are made of conductive material. One advantage of having the conductive bumps on a case instead of the device itself is that it can allow existing devices that do not have built-in conductive bumps to work with embodiments of the disclosure. As far as the touch panel of the touch sensing device is concerned, there may be no difference whether the conductive bumps are affixed to the back surface of the device or to the case wrapped around the device.

Although FIG. 2 illustrates a specific triangle configuration of the conductive bumps, it should be understood that the number, size, shape, and relative position of the conductive bumps can vary so long as that they form a configuration that is unique to one particular type of device (or, in some embodiments, one particular device) and recognizable by a touch sensing device.

FIG. 3 provides a side view of the portable electronic device of FIG. 2 on top of touch sensing device 300 equipped with a capacitive touch panel 302. The touch panel 302 of the touch sensing device 300 can include a capacitive touch sensor panel similar to the one illustrated in FIGS. 1a-c. The touch panel 302 of the touch sensing device 300 can be multi-touch enabled for detecting multiple touches at the same time. As illustrated in FIG. 3, the portable electronic device 200 can be positioned such that its back surface 200 (the surface opposite the display) is facing the touch panel 302 of the touch sensing device 300 and only the conductive bumps or areas 202 protruding from or formed on the back surface 200 of the portable electronic device are in contact with the touch panel 302. Because the conductive bumps 202 can behave like any other conventional touch object such as a stylus or a finger, the touch by each of the conductive bumps can be detected by the touch panel 302 and translated into touch data. Such touch data can encode the number, size, location, and other information relating to the touches by the conductive bumps. A processor in the touch sensing device 300 can then determine the specific configuration of the conductive bumps based on the touch data. In this embodiment, the touch sensing device 300 can be programmed to recognize, based on the configuration, that the device placed on top of the touch sensor panel is a particular type of portable electronic device.

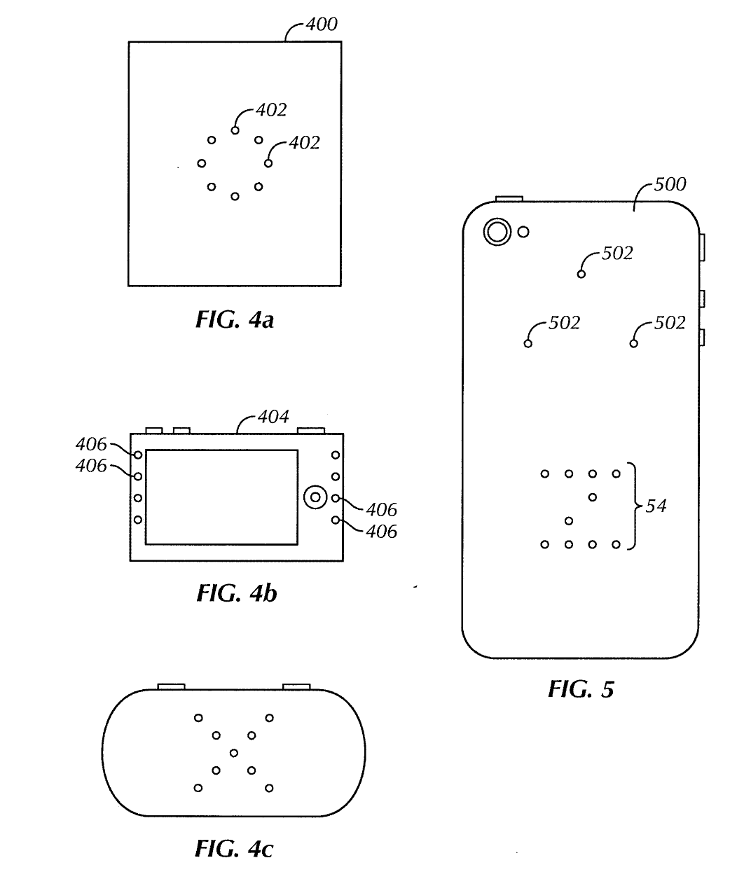

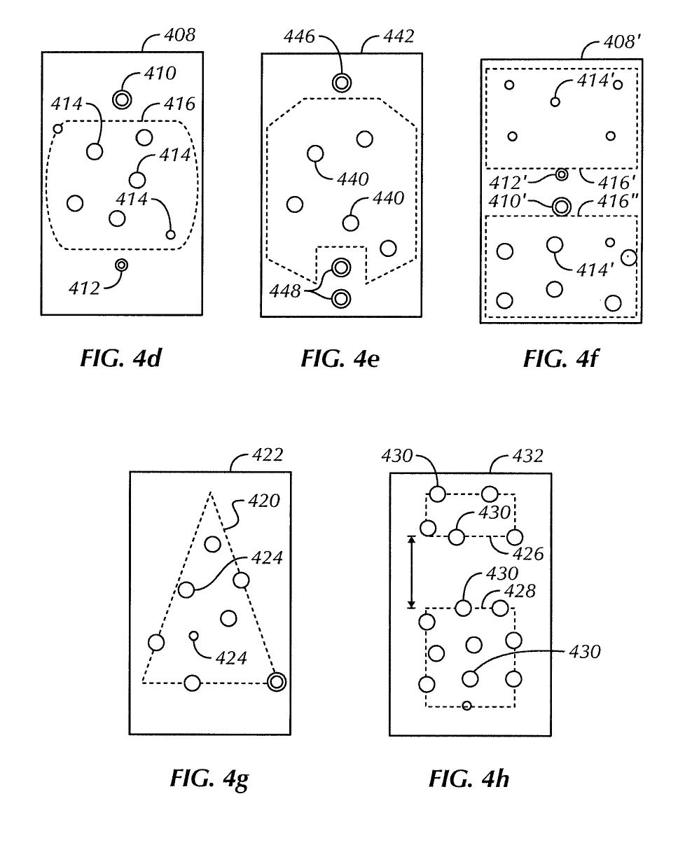

The touch sensing device 300 can be similarly programmed to recognize other unique configurations of conductive bumps that can identify other types of devices. FIGS. 4a-c illustrate various exemplary configurations of conductive bumps that can be used to identify different portable electronic devices. For example, eight conductive bumps 402 arranged in a circle as shown in FIG. 4a can identify an iPod Nano® from Apple Inc. of Cupertino, Calif. Two columns of four conductive bumps 406 each, as shown in FIG. 4b, can identify a digital camera. And in FIG. 4c, conductive bumps in an “X” configuration can identify a handheld gaming console. Because the configurations of conductive bumps on the back of the various types of portable electronic devices are different from each other, they can provide identification information to a touch sensing device. In this embodiment, it can be essential for the touch sensing device to determine the type of touch object device so that the touch sensing device can initiate communication using a proper channel supported by the touch object device.

As mentioned above, the conductive bumps can be arranged in any configuration so long as the configuration is unique to that particular type of device. A universal directory can be created to match configurations with electronic devices. This directory can be loaded into any potential touch sensing devices and used during the identification process described above to identify the different touch object device types. In some embodiments, a particular configuration includes two or more conductive bumps because a touch by a single bump may not be distinguishable from a touch by a finger or a stylus. The various configurations of conductive bumps can be distinguished from each other based on, for example, the overall pattern formed of the bumps, the number of bumps in the configuration, the distances between the bumps, and the shape and/or size of the touch area of the bumps. For example, one configuration can include one large square-shaped conductive bump and two smaller round-shaped conductive bumps. The size and shape of the conductive bumps can vary, even for bumps in the same configuration.

In some embodiments, the conductive bumps in a configuration can be kept at a minimum distance from each other so that the touch panel can accurately determine the location of each of the conductive bumps in the configuration. In one embodiment, for example, the minimum distance between any two conductive bumps can be one inch. The minimum distance can depend on the resolution or other physical attributes of the touch panel. In another embodiment, the conductive bumps can be kept at a certain minimum distance from the edge of the casing of the touch object device to avoid confusion with other conductive materials near the edge and fields generated by the operation of the touch object device. Additionally or alternatively, the casing of the touch object device can be made of a substance not likely to trigger a capacitive reaction with the touch panel of the touch sensing object. In general, the conductive bumps do not necessarily have to protrude from the back surface of the touch object device or a case for the touch object device as long as their configuration can be easily captured by a touch panel. In the embodiment where the back surface of the touch object device is a flat surface, the conductive bumps on the back surface may have the same height to ensure that they can be uniformly detected by the touch panel when the touch object device is placed in contact with the touch panel of a touch sensing device.

Because the conductive bumps can interact with a touch panel in a similar fashion as a finger or a stylus, no significant change or modification may be required for the touch sensing device which detects the touches of the conductive bumps. In particular, no significant structural changes to the touch hardware of the capacitive touch panel may be necessary. In the embodiments where the conductive bumps are static, the only modification to the touch object device may be to mold the back surface of the devices (or the cases for the devices) slightly differently. Accordingly, embodiments of the disclosure can be relatively inexpensive to implement. Some changes to the software and/or firmware of the touch sensing device may be required so that the device can properly process the touch data from the touches of the conductive bumps. The various conductive bump configurations can be stored in a memory of the touch sensing device and recalled by the processor during operation to find a match for a configuration detected by the touch panel. Because software updates can be easily carried out even after the touch sensing device is manufactured and put to use, it is possible to implement embodiments of the disclosure using existing multi-touch enabled electronic devices.

In embodiments where the conductive bumps are built on or into a case instead of the device itself, a unique configuration of the conductive bumps can be associated with the device by simply putting the case on the device. In one embodiment, the configuration is additionally linked to the particular device by a unique identification number. That is, each unique configuration on a case can have a unique identification number associated with it. The number can be manually entered into the device when the case is put on the device so that the device can also be uniquely identified by the unique configuration assigned with the identification number. This can ensure that when the configuration of conductive bumps is created by a third-party vendor of after-market cases for a particular type of device, the configuration can still be recognized by the touch sensing devices.

In some embodiments, in addition to identifying the type of the various touch object devices based on their conductive bump configurations, the touch sensing device (e.g., iPad®) can also use the detected configuration of the conductive bumps to determine and track the location and orientation of the touch object device on its touch surface. For example, when a user starts to rotate a touch object device after it has been placed on the touch panel while maintaining contact between the conductive bumps on the touch object device and the touch panel, the change in the touch locations of the conductive bumps can also be captured by the touch panel and processed to determine the relative movement of the touch object device on the touch panel.

In one embodiment, the placement of the conductive bumps can be rotationally asymmetric to ensure that the bumps can be uniquely identified and their orientation can be determined. FIGS. 4d-h illustrate exemplary bump configurations suitable for tracking the orientation of the touch object device. In the bump configuration illustrated in FIG. 4d, the two farthest-away conductive bumps 410, 412 can be used to identify the orientation of the touch object device 408. For direction sensing, one of the two conductive bumps 410 can be larger than the other one 412. The remaining conductive bumps (collectively 414) can be placed anywhere between the two farthest-away conductive bumps 410, 412 within a usable data matrix area 416 (shown in dotted line). Some of these remaining conductive bumps 414 (e.g., the larger ones) can be used to encode and transmit data to another device, as will be discussed in detail below. Others (e.g., the smaller ones) can be used solely for identifying the touch object device 408. In addition, the midpoint between the two farthest-away conductive bumps 410, 412 can be used to identify the center of rotation.

FIG. 4e illustrates a variation of the embodiment in FIG. 4d. In the configuration shown in FIG. 4e, all the conductive bumps 440 can have the same size. Instead of using the two farthest-away bumps of different sizes to identify the orientation and direction of the device 442, this configuration can include one conductive bump 446 at one end and two conductive bumps (collectively 448) on the opposite end to identify the orientation and direction of the device 442. The remaining bumps 440 can be used to identify the device 442.

FIG. 4f illustrates another configuration in which the nearest conductive bumps 410′, 412′ can be used to identify the orientation of the touch object device 408′. As in the previous embodiment, the different sizes of these two bumps 410′, 412′ can indicate the direction of the touch object device ‘408. In this embodiment, the remaining conductive bumps (collectively 414′) are grouped within two usable data matrix areas 416′, 416″ with the larger conductive bumps for transmitting data in one area 416″ and the smaller conductive bumps for identifying the touch object device 408′ in the other area 416′. The midpoint between the two nearest conductive bumps 410′, 412″ can be used to identify the center of rotation.

In the configuration shown in FIG. 4g, an isosceles triangle, which is significantly scaled away from equilateral, can form the boundary of the usable data matrix area 420 in which all conductive bumps (collectively 424) are located. The matrix area 420 may include a minimum number of detectable conductive bumps so that the triangle shape of the area can always be sensed. In various embodiments, this can be achieved by greycoding or placing anchor bumps at at least two vertices of the triangle area or any other known methods. Accordingly, the isosceles triangle can indicate the orientation of the touch object device 422. In one embodiment, the center of the device can be defined as the center of the incircle of the triangle 420.

In the configuration illustrated in FIG. 4h, two matrices 426, 428 of different physical area can exist in two regions of the back surface of the device 430. The two matrices can be formed by guaranteed placement of conductive bumps (collectively 430) at their edges based on the encoding used, or by key bumps identifying their size individually, such that the two matrices 426, 428 can have a gap between them larger than the gaps between the individual conductive bumps inside each of the matrices 426, 428. In this configuration, one of the matrices 428 can be larger than the other one 426 and the relation between them can identify rotation and direction of the device 430. The midpoint of the center of the two matrix areas can designate as the center of the device 430.

The orientation and rotational information can be used by the touch sensing device to initiate certain actions. For example, an image such as a picture or a map displayed on the touch sensing device can be rotated in accordance with the rotating of the touch object device on the touch panel. Similarly, the image can also be dragged in any direction in accordance with the movement of the touch object device on top of the touch sensing device.

Although the above-discussed embodiments may, on occasion, discuss specific devices such as the iPhone® and the iPad® as the touch object device and touch sensing device, respectively, it should be understood that many other portable electronic devices can be fitted with conductive bumps to be used as a touch object device, and any electronic device with a multi-touch panel can be used as a touch sensing device according to embodiments of the disclosure. In some embodiments, the touch object device can be smaller than the touch sensing device so that at least part of the touch panel of the touch sensing device is visible to the user when the touch object device is placed on the touch panel of the touch sensing device.

In another embodiment, the configuration of the conductive bumps on the back of the touch object device can also be used to initiate certain operations on the touch sensing device or communications between the two devices. For example, a particular configuration of the conductive bumps can initiate a synchronization operation of the data stored on the touch object device and the touch sensing device. That is, the configuration serves the dual functions of identifying the touch object device to the touch sensing device and initiating synchronization between the two devices. The actual data transfer between the devices can be done using any known mechanism. For example, if the touch object device and the touch sensing object are equipped with wireless capabilities such as WiFi and/or Bluetooth, data can be transferred using one of the available wireless channels. The devices can also communicate via existing cellular networks after using the touch panel for the initial pairing.

In one embodiment, when the touch sensing device (e.g., an iPad®) detects a unique configuration of touch pattern on its touch panel, it can determine, based on that configuration, for example, that a portable MP3 player has been placed on its touch panel. Furthermore, the unique configuration can also cause the setting of the portable MP3 player to be synchronized with the setting of the iPad® using a WiFi connection between the two devices. In other embodiments, the configuration of the conductive bumps on a touch object device can initiate other operations such as exchanging messages and transferring files (e.g., MP3 files, pictures, video clips) between the two devices via wireless channels.

In the embodiments discussed above, a particular configuration of conductive bumps can both identify the touch object device and initiate a specific operation on the touch sensing device. In other embodiments, some of the conductive bumps in a configuration can be used to identify the type of a touch object device and the remaining ones can be used to provide additional information, such as Bluetooth pairing code, unique to a particular device. FIG. 5 illustrates the back surface of a touch object device with an exemplary configuration. As illustrated, the top three conductive bumps (collectively 502) in a triangle sub-configuration can identify the device 500 as an iPhone®, for example. The bottom ten conductive bumps in a “Z” sub-configuration can be used to encode the Bluetooth pairing code for this particular device. The touch sensing device (not shown in FIG. 5)) in this embodiment can be programmed to recognize both sub-configurations from the overall touch image captured by its touch panel. The type of configuration such as the one illustrated in FIG. 5 can be especially useful when, for example, there are a number of Bluetooth devices close by and the touch sensing device needs to determine which one of those Bluetooth devices is the one placed on its touch panel (i.e., the one it should to be paired with using Bluetooth).

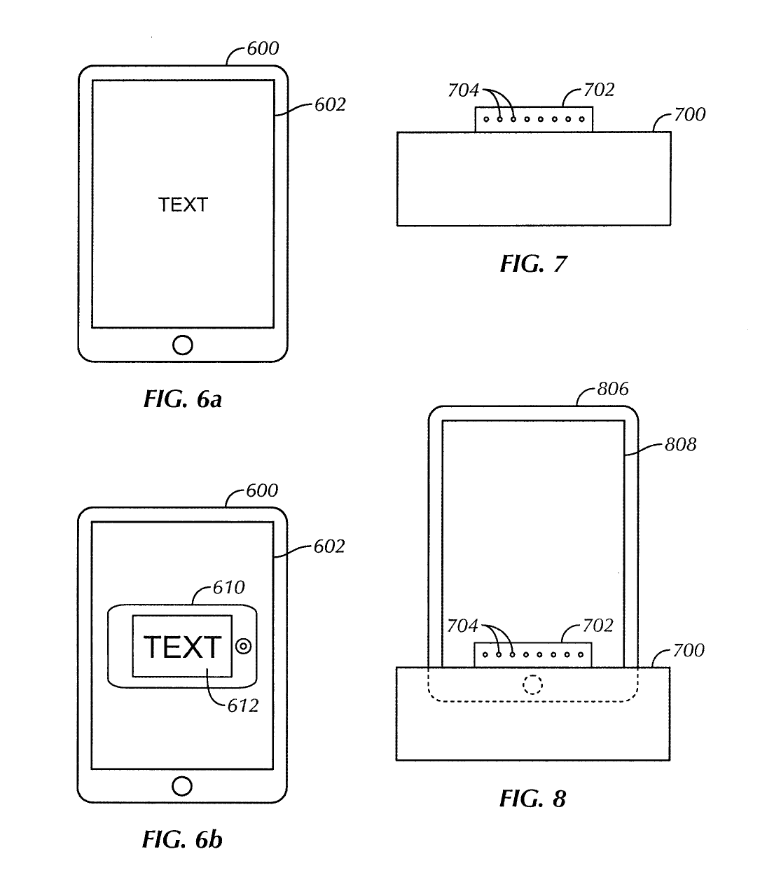

In addition to initiating data syncing between the touch object device and the touch sensing device, many other operations can be performed after the touch object device and the touch sensing device are successfully paired, for example via wireless connection. In one embodiment, when a portable electronic device with a unique configuration of conductive bumps is placed on top of a larger touch sensing device having a touch screen, the touch object device can mimic a magnifying glass for reading text on the touch sensing device. FIG. 6 illustrates touch sensing device 600 having a touch screen display 602 which displays some “TEXT” in relatively small font size. As illustrated in FIG. 6b, when a touch object device 610 with conductive bumps on its back surface is placed on the top of the touch screen display 602 of the touch sensing device 600, the touch sensing device can identify the touch object device based on the configuration of the conductive bumps and initiate a wireless connection with the touch object device 610 using methods discussed above. In addition, the touch sensing device 600 can also determine the location and orientation of the touch object device 610 based on the location of each of the conductive bumps on the back of the touch object device 610. In other words, the conductive bumps can also provide orientation and translation information that allows the touch sensing device 600 to determine an area of its touch screen display 602 that is directly overlapped by the touch object device 610.

Once a wireless communication channel is established between the devices, the touch sensing device 600 can transmit information regarding what is being displayed in the area covered by the touch object device 610 to the touch object device. With that information, the touch object device 610 can display a magnified version of the text displayed in the area of the touch screen display of the touch sensing device directly underneath it, as illustrated in FIG. 6b. In addition, when the touch object device 610 is moved around on the touch screen display of the touch sensing device 600, the touch sensing device can continuously update the touch object device on what is being displayed in the area covered by the touch object device. Accordingly, the touch object device 610 can refresh its display 612 to display a magnified version of what is displayed on the touch sensing device 600, thereby creating an effect as if a magnifying glass is being moved around above the touch screen 602 of the touch sensing device. The orientation and direction of the touch object device 610 can be determined, for example, using conductive bumps arranged in configurations illustrated in FIGS. 4d-h.

In another embodiment, using the same basic concept, a touch object device can be used as an instant translator for translating words displayed on a touch sensing device. As in the embodiment disclosed in the last paragraph, the touch object device can be placed on top of the touch sensing device and moved around, and the touch sensing device can identify the touch object device by the conductive bumps on the back of the touch object device and establish a wireless communication channel with the touch sensing device. The touch sensing device can also determine the location of the touch object device with respect to its touch screen display. The text displayed in the area of the display of the touch sensing device directly underneath the touch object device can be translated using an application installed on the touch sensing device and transmitted via the wireless channel to the touch object device where it can be displayed on its display. Alternatively, the original text can be transmitted via the wireless channel to the touch object device and an application installed on the touch object device can perform the translation. As a result, this creates an effect that, as the touch object device is moved around the touch screen display of the touch sensing device, text displayed in an area of the touch sensing device display directly underneath the touch object device is translated instantaneously and displayed on the display of the touch object device.

In yet another embodiment, an item such as a picture or a MP3 file displayed on a touch object device can be transferred to a touch sensing object by placing the touch object device on the touch screen of the touch sensing device and “dragging' the file off the touch object device and onto the touch sensing device. This also requires that the devices be first paired and connected using methods discussed above. Then, the displayed item can be dragged towards the edge of the display of the touch object device in response to a dragging gesture detected over the item. As it reaches the edge of the display of the touch object device, the file can appear to be moved off of the display of the touch object device and appear on the display of the touch sensing device as if it has been dragged from the touch object device to the touch sensing device. This can also be performed in the reverse direction to drag a file from the touch sensing device to the touch object device. By allowing the user to set his touch object device down on the touch screen of the touch sensing device and simply drag an item from one device to the other device, this embodiment of the disclosure provides a seamless and intuitive way of transferring files between the devices.

In some other embodiments, after the touch sensing device identifies the touch object device using the conductive bumps on the touch object device and establishes a wireless connection to the touch object device, the touch object device can be removed from the touch screen of the touch sensing device while maintaining the wireless connection with the touch sensing device. This way, the devices can remain connected and perform certain operations together. For example, a computer game can be played on a touch sensing device by using a smaller touch object device such as an iPod Nano® as a controller. The iPod Nano® can be fitted with conductive bumps on its back surface and placed on the touch screen of the touch sensing device to pair the two devices using methods disclosed above. A wireless connection between the two devices can be established and then the iPod Nano® can be removed from the touch sensing device touch screen and used to control the game remotely.

In another embodiment, multiple touch object devices can be paired with a single touch sensing object. Each of the multiple touch object devices can have a different unique configuration of conductive bumps on its back surface to uniquely identify it to the touch sensing object. During the initial pairing, the touch object devices can be placed onto the touch panel of the touch sensing device one-by-one or simultaneously. Once all the touch object devices are successfully paired with the touch sensing device using the conductive bumps, they can work simultaneously with the touch sensing object. For example, two touch object devices (e.g., an iPod Nano® and an iPhone®) can be used as two wireless controllers to play a multi-player game running on a touch sensing object (e.g., an iPad®). In addition, a direct connection between the two touch object devices can be established by pairing them through the touch sensing device while both touch object devices are placed on the touch panel of the touch sensing device. That is, after the touch sensing device identifies each of the touch object devices based on its unique conductive bump configuration, the touch sensing device can swap connection information between the touch object devices so that the touch object devices can communicate directly with each other using, for example, WiFi or Bluetooth.

One common trait of the conductive bump configurations described in the exemplary embodiments above is that the conductive bumps can be all static. That is, the configuration of the conductive bumps for a particular type of device or a particular device can be fixed and cannot be changed after the device or the case is built. As discussed above, these static conductive bumps may be sufficient for identifying the touch object devices to a touch sensing object, providing location information of the touch object device, and can even encode a limited amount of information to a touch panel for the purpose of initiating an operation on the touch sensing device. Nevertheless, the static bumps can be primarily designed for identification purposes, and may have limited use as a communication channel for transmitting information between a touch object device and a touch sensing device. The embodiments discussed below introduce reconfigurable bump configurations that are well-suited for encoding and transmitting information from a touch object device to a touch sensing device.

In a first embodiment, the configuration of conductive bumps on the back surface of a touch object device can be dynamically adjusted by changing the conductivity of each of the bumps in the configuration. In this embodiment, the conductive bumps can be embodied directly on a surface of the touch object device. The conductivity of each of the bumps can be adjusted by control circuitry in response to user input received by the touch object device or automatically in accordance with programs running on the touch object device. For example, when a bump is assigned a value of 1, control circuitry coupled to the conductive bumps can cause the particular bump to become conductive and thus detectable by a touch panel. In contrast, when a bump is assigned a value of 0, the bump is no longer conductive and thus can become undetectable by the touch panel.

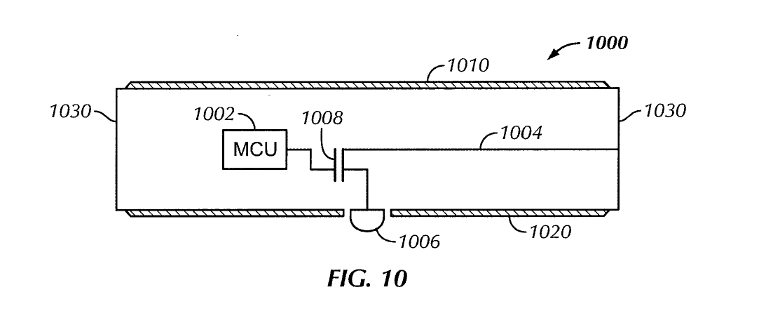

In one embodiment, the conductivity of the bump can be controlled by a control circuitry such as the one illustrated in FIG. 10. FIG. 10 provides a side view of a touch object device 1000. In this embodiment, the top and bottom surfaces 1010 and 1020 of the touch object device 1000 can be made of insulators, such as glass. The side surface 1030 of the touch object device can be made of a conductive material, such as metal. A conductive bump 1006 is shown to be on the bottom surface 1020 of the touch object device 1000. The conductive bump 1006 can be connected to the side surface 1030 via a conductive path 1004. Because the side surface 1030 is conductive, when it is in contact with a user, it can serve as ground for the conductive bump 1006. This allows the conductive bump 1006 to be detectable by a capacitive touch panel when it makes contact with the touch surface of the touch panel. In this embodiment, the conductive path 1004 connecting the conductive bump 1006 to ground 1030 can include a switch 1008, such as a field-effect transistor (FET). The switch 1008 can be controlled by a microcontroller (MCU) 1002. When the MCU 1002 turns off the switch 1008, the conductive path 1004 connecting the conductive bump 1006 to ground 1030 can be broken. As a result, the conductive bump 1006 can no longer be detected by a touch panel even though it remains in contact with the touch panel. Thus, by turning on and off the switch, the MCU 1002 can essentially change the conductivity of the conductive bump 1006 (i.e., control whether the bump 1006 can be detected by a touch panel).

Accordingly, the configuration of the bumps on the back of a touch object device can be dynamically changed by setting the bumps to different values (e.g., 0 or 1). A fixed protocol can be created to encode information using various bump configurations so that the information can be transmitted to a touch sensing device through its touch panel. Customized protocols can also be created by assigning different input commands to different bump configurations. At least one bit of information can be transmitted by changing the conductivity of one of the bumps in a configuration. For example, a simple “YES” or “NO” can be transmitted by making a single bump conductive or nonconductive. As another example, more complex messages can be transmitted by switching a single bump between conductive and nonconductive states for various durations to simulate a Morse code transmission.

In another embodiment, a modified physical keyboard can be used to work with a conventional touch screen. FIG. 7 illustrates the back side of an exemplary keyboard 700. A strip 702 can be attached to the side of the keyboard 700. In this embodiment, eight reconfigurable bumps (collectively 704) can protrude from the back of the strip 702. Although eight are illustrated in the figure, it should be understood that there can be any number of bumps on the strip. Each of the eight reconfigurable bumps 704 can be dynamically switched between conductive and nonconductive states to transmit eight bits of information at a time. In this embodiment, each key on the keyboard can be assigned to a unique eight-bit binary number and each key can be connected, either electronically or mechanically, to a controller controlling the conductivity of the bumps on the strip. When a user press a key on the keyboard, the key is translated into a corresponding eight-bit binary number and the controller reconfigures the bumps 704 to encode this eight-bit binary number.

When in use, as illustrated in FIG. 8, the modified keyboard 700 can be placed adjacent to a touch sensing device 806 so that the strip extending from the keyboard can at least partially overlap with the touch screen display 808 of the touch sensing device 806. This allows the reconfigurable bumps 704 on the back of the strip 702 to be in contact with the touch screen 808. Initially, all eight bumps can be turned on (i.e., set in a conductive mode) and the touch screen 808 can detect the touches by the bumps in their default configuration. Using methods discussed above, the touch sensing device 806 can determine from the default configuration that a modified keyboard 700 has been placed in contact with the touch screen 808 to input data. In response, the touch sensing device can automatically switch to a data receiving mode in which the different touch configurations received subsequently by the touch screen can be translated into the corresponding key strokes from the keyboard. Thus, when a user starts typing on the physical keyboard, the bump configuration on the back of the strip can change accordingly. The bump configuration, as it changes, can be captured by the touch screen 808 and decoded back to characters which can then be displayed on the touch screen 808. This allows the user to use a physical keyboard for data entry on a touch screen. As in other embodiments of the disclosure, no modification may be necessary for the touch hardware in the touch sensing device. However, the touch sensing device may be loaded with a directory of the keys of the keyboard and their corresponding 8-bit numbers so that it can decode the detected bump configurations.

In the embodiment illustrated in FIGS. 7 and 8, a touch object device (e.g., the keyboard) can actively transfer information via the touch screen of a touch sensing device by dynamically changing its bump configuration. This provides a direct mechanism to interact with the touch sensing device via the touch screen without having to establish a secondary communication channel such as a wireless connection. This can reduce power consumption by the touch sensing device when operated by a touch object device because it can turn off some components such as the WiFi and Bluetooth transmitters and receivers while data entry is carried out using the external physical keyboard through the touch screen.

Although the configurable bumps are discussed in the exemplary embodiment of a physical keyboard above, it should be understood that any touch object device (e.g., a smartphone and a portable MP3 player) can also be equipped with configurable bumps for encoding and transmitting information to another device via a touch panel.

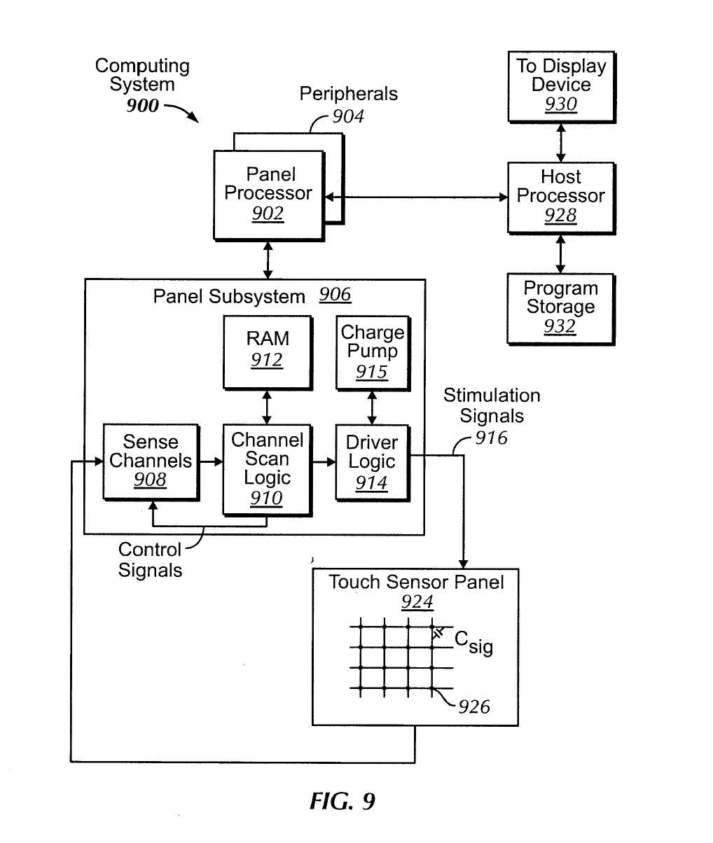

As described above, touch-based input devices such as touch screens and touch panels can be one type of device used for detecting the configuration of conductive bumps on another device. These touch-based input devices can use any existing touch technologies including, but not limited to, capacitive, resistive, in infrared and acoustic touch technologies. FIG. 9 illustrates exemplary touch sensing device 900 according to embodiments of the disclosure. The device 900 can include one or more touch panels and/or touch screens according to the embodiments of the disclosure described above. The device 900 can include one or more panel processors 902 and peripherals 904, and panel subsystem 906. Peripherals 904 can include, but are not limited to, random access memory (RAM) or other types of memory or storage, watchdog timers and the like. Panel subsystem 906 can include, but is not limited to, one or more sense channels 908, channel scan logic 910 and driver logic 914. Channel scan logic 910 can access RAM 912, autonomously read data from the sense channels and provide control for the sense channels. In addition, channel scan logic 910 can control driver logic 914 to generate stimulation signals 916 at various frequencies and phases that can be selectively applied to drive lines of touch sensor panel 924. In some embodiments, panel subsystem 906, panel processor 902 and peripherals 904 can be integrated into a single application specific integrated circuit (ASIC).

Touch sensor panel 924 can have the same structure as the one illustrated in FIG. 1a. The device 900 can also include host processor 928 for receiving outputs from panel processor 902 and performing actions based on the outputs that can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 928 can also perform additional functions that may not be related to panel processing, and can be coupled to program storage 932 and display device 930 such as an LCD panel for providing a UI to a user of the device. Display device 930 together with touch sensor panel 924, when located partially or entirely under the touch sensor panel, can form touch screen 918.

In some embodiments, the panel processor 902 can execute software routines stored in non-transitory computer readable storage media such as RAM 912 to process the raw touch data from the touch sensor panel 924 as produced by the conductive bumps and perform the identification, configuration and communication operations described above.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. An electronic device, comprising:
a device housing;
a first surface coupled to the device housing; and
a plurality of conductive bumps on the first surface, the conductive bumps configured to be detectable by a capacitive touch panel of a touch sensing device when placed in contact with the capacitive touch panel and having a unique configuration that identifies the electronic device to the touch sensing device.

2. The electronic device of claim 1, further comprising control circuitry connected to the conductive bumps and capable of adjusting the configuration of the conductive bumps.

3. The electronic device of claim 2, wherein adjusting the configuration of the conductive bumps comprises adjusting the conductivity of one or more of the conductive bumps.

4. The electronic device of claim 3, wherein each of the conductive bumps is configured to transmit one bit of information.

5. The electronic device of claim 1, wherein the first surface is detachable from the device housing.

6. The electronic device of claim 1, wherein the unique configuration comprises some but not all of the conductive bumps.

7. The electronic device of claim 1, wherein part of the unique configuration encodes a command for initiating an operation on the second device.

8. The electronic device of claim 7, wherein the operation comprises establishing a communication channel between the electronic device and the touch sensing device.

9. The electronic device of claim 8, wherein the communication channel is a wireless channel.

10. The electronic device of claim 7, wherein the operation comprises transferring data between the electronic device and the touch sensing device.

11. The electronic device of claim 1, wherein the unique configuration of the conductive bumps identifies an orientation of the device.

12. The electronic device of claim 1, wherein the electronic device is one of a cellular phone, portable music player, camera, and handheld game console.

13. A touch sensing device, comprising:
a capacitive touch panel capable of detecting multiple touches at about the same time, the capacitive touch panel responsive to a plurality of contacts from a plurality of conductive bumps on a touch object device; and
a processor configured to identify the touch object device based on a configuration of the conductive bumps detected by the capacitive touch panel, the configuration unique to the touch object device.

14. The touch sensing device of claim 13, further comprising a memory for storing a directory of touch object devices and their corresponding bump configurations.

15. The touch sensing device of claim 13, further comprising transmitting and receiving means for transmitting and receiving data from and to the touch object device after the touch object device is identified based on the unique configuration.

16. The touch sensing device of claim 13, wherein the processor is further configured to decode a command encoded in the configuration of the conductive bumps detected on the capacitive touch panel.

17. The touch sensing device of claim 16, wherein the processor is further configured to initiate an operation in response to the decoded command.

18. The touch sensing device of claim 17, wherein the operation comprises establishing a communication channel with the touch object device.

19. The touch sensing device of claim 13, wherein the configuration identifies at least two touch object devices in contact with the capacitive touch panel.

20. The touch sensing device of claim 13, wherein the processor is further configured to determine a location and orientation of the touch object device in response to the detected configuration.

21. The touch sensing device of claim 13, wherein the touch sensing device is a tablet PC.

22. A method of pairing a first device having a touch panel and a second device having a plurality of conductive bumps on one of its surfaces, the method comprising:
detecting, on the touch panel of the first device, a plurality of touches by the conductive bumps on the second device;
identifying a type of the second device in response to a configuration of the plurality of conductive bumps as detected by the touch panel;
determining a communication protocol shared by the devices based on the second device type; and
establishing a connection between the first and second devices using the determined communication protocol.

23. The method of claim 22, further comprising synchronizing the first and second devices after the connection is established.

24. The method of claim 22, further comprising:
detecting, by the touch panel of the first device, a change in the configuration of the detected touches in response to the conductive bumps on the second device being reconfigured; and
decoding information encoded in the changed configuration of the detected touches.

25. The method of claim 23, further comprising:
initiating an operation in response to the decoded information.
